(19) United States
(12) Patent Application Publication
(10) Pub. No.: US 2022/0383065 A1
(43) Pub. Date: Dec. 1, 2022

(54) METHOD FOR PROCESSING INPUT DATA

(71) Applicant: EYYES GMBH, Gedersdorf (AT)

(72) Inventors: Johannes TRAXLER, Imbach (AT); Ilkay WUNDERLICH, Dresden (DE); Sven SCHÖNFELD, Dresden (DE)

(73) Assignee: EYYES GMBH, Gedersdorf (AT)

(21) Appl. No.: 17/774,513

(22) PCT Filed: Nov. 5, 2020
(86) PCT No.: PCT/EP2020/081156

§ 371 Date: May 5, 2022

(30) Foreign Application Priority Data
Nov. 5, 2019 (DE) 10 2019 129 760.5

(51) Int. Cl. G06N 3/04

(52) U.S. Cl. CPC G06N 3/04

(57) ABSTRACT

A computer-implemented method for processing data in which the input data are analyzed using a number of serially arranged filters defining a filter criterion and generating result data in a plurality of serial or parallel filtering method steps. The result data, corresponding to the filter criterion and including result values, are generated. A weighting factor is associated with each filter, and the number of filters in the filtering method steps is constant.

### CROSS-REFERENCE TO RELATED APPLICATIONS

The present application is a national phase application of PCT Application No. PCT/EP2020/081156, filed Nov. 5, 2020, entitled “METHOD FOR PROCESSING INPUT DATA”, which claims the benefit of German Patent Application No. 10 2019 129 760.5, filed Nov. 5, 2019, each of which is incorporated by reference in its entirety.

### BACKGROUND OF THE INVENTION

### 1. Field of the Invention

The invention relates to a computer-implemented method for processing input data; in particular in deep-learning CNN, and further relates to logic modules for carrying out such methods.

### 2. Description of the Related Art

It is known according to the background of the art that in convolutional neural networks (CNN) the input data are analyzed using a number of filters that varies depending on the respective analysis task, each filter having at least one filter criterion (also referred to as a filter parameter). According to the background of the art, digital filters, mathematical filters and analog filters as well as their mode of operation are known. The incoming data are modified by applying the variable number of filters in layers arranged between an input layer and an output layer—also referred to as hidden layers (see WO2018112795)—and generating result data. The result data includes result values, the result values corresponding to the filter criterion. The application of the filters to the input data and the generation of result data are weighted according to common teaching by means of weighting factors associated with the filters. The nature and functionality of CNN is described, for example, in the online encyclopedia Wikipedia and further in the present disclosure.

In methods according to the background of the art, even when a neural network is used, further calculation programmes are required to detect those filters with a non-relevant filter criterion and/or without relevant influence on the final result and to delete them from the method to be applied according to the background of the art. These non-relevant filters are recognized during the process of teaching the CNN, wherein the deletion that has taken place cannot be reversed as such, but the CNN must be re-taught to reintroduce the previously deleted filters. The person skilled in the art will recognize that identifying unneeded filters and classifying those filters as non-relevant filters requires computational power. The person skilled in the art knows “pruning” or “spiking” as exemplary approaches.

The fact that filters classified as non-relevant are deleted from the method to be applied makes the methods rigid and not further adaptable according to the background of the art. The CNN is deprived of the possible favourable property of performing further learning using further filters with further filter properties during operation of the CNN (so-called inference operation), the further filters with further filter properties having been classified as non-relevant under application of the common teaching during the previously performed process of teaching the CNN and having been deleted.

EP3480746 is based on a connection between a detection of a filter and the association of the weighting factors. There is no reference in EP3480746 to a constant number of sequentially arranged filters or filtering method steps running parallel to one another.

WO2019074804A1 does not provide any indication of a defined number of filters.

In US201900887725 the number of filters is selected depending on the axes of a multidimensional color space. US201900887725 does not disclose the use of weighting factors for weighting the influence of the filters on the result data.

US20190080507 mentions in the definition of the number of filters as a function of the axes of the multidimensional color space. However, US20190080507 does not contain any reference to the use of weighting factors to evaluate properties. Even when repeating the method disclosed in US20190080507 with a constant number of axes in the multidimensional color space and with a consequently constant number of filters, the method disclosed in US20190080507 differs by the feature of the weighting factors, by means of which weighting factors the influence of the filters on the result data can be controlled in each method step. If the method disclosed in US20190080507 were to be repeated, this method would deliver the same result data in each method step.

WO2018106805A1 provides no indication of a constant number of filters between the method steps.

WO2017152990 contradicts the basic idea of the method according to the invention disclosed below, comprising a static number of filters, by aiming at a reduction of the multiplication operations by a reduction of the layers (page 6-7).

U.S. Pat. No. 6,389,408 mentions a Müller matrix for detecting biological and chemical materials. This is not an indication of a constant number of sequentially arranged filters or of filtering method steps running parallel to one another.

The solution approach of EP0566015A2 does not include a static number of sequentially arranged filters or filtering method steps running parallel to one another.

No reference is made in EP1039415 to a static number of sequentially arranged filters or a static number of filtering method steps running parallel to one another.

US20180137414, US20180137417 are known as publications according to the background of the art. US20180137414 defines that a deep-learning CNN comprises at least three layers or filters for processing input data. US20180137414, US20180137417 only describe the sequential switching of the filters. US20180137414 does not provide any indication of a constant number of filters when the method is repeated. In addition, this application focuses on optimization by avoiding filter operations dependent on the input data by means of LKAM and not on the parallelized processing of input data for an entire layer.

Analysis methods according to common teaching are carried out as computer-implemented methods. In an analysis of input data in neural networks using methods according to the background of the art, the input data are analyzed by means of a number of filters with the generation of result data (also referred to as output data) in a number of filtering method steps. The result data includes result values and response values.

### SUMMARY OF THE INVENTION

In a first variant, the invention disclosed below relates to a computer-implemented method for processing input data; in particular in deep-learning CNN, wherein the input data are analyzed using a number of filters defining a filter criterion and generating result data in one filtering method step or in a plurality of filtering method steps, whereby the result data corresponding to the filter criterion and comprising result values are generated, wherein a weighting factor is associated with the at least one filter.

In second and third variants that are independent of the first variant, the invention relates to a method with the features of the claims, logic modules for carrying out such methods, a logic module with the features of the claims, a device having such a logic module, computer programs for carrying out the methods, and a storage medium.

The input data can, for example, be predetermined data or data stored in a database. The input data can also be data determined by means of a sensor. The following discussion of the method according to the invention according to the first or second variant focuses on the analysis of image data as predetermined data or data that can be determined by means of a sensor. However, the application of the method according to the invention according to the first, second or third variant is in no way limited to the analysis of image data.

In the same way, the method according to the invention can also be applied to other data according to the first, second or third variant. The data can be dynamic, therefore time-varying data, as well as static data. The dynamic data can, for example and thus not limited thereto, be data whose content can change according to a certain pattern or can change freely. The measured or predetermined data can also be machine data describing the functionality of a machine or personal data describing human behavior.

According to common teaching, the result data can be generated from the input data by means of filters arranged in series or by means of filters arranged in parallel.

According to the first embodiment of the invention, the filtering method steps can be used in methods that do not necessarily require a neural network. Known examples are Prewitt filtering methods, Wavelet filtering methods or Frame-Theory-Analysis methods. If no neural network is used, the parameters of the filters used in these filtering methods must be created with existing prior knowledge. When using a neural network, the parameters of the filters used can be taught (training of the neural network using training data).

### BRIEF DESCRIPTION OF THE DRAWINGS

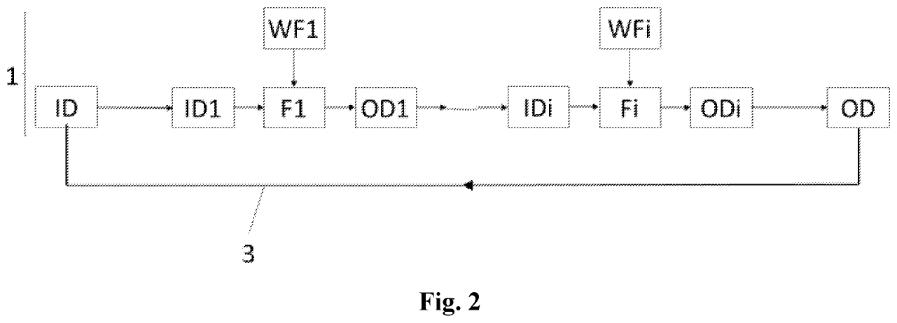

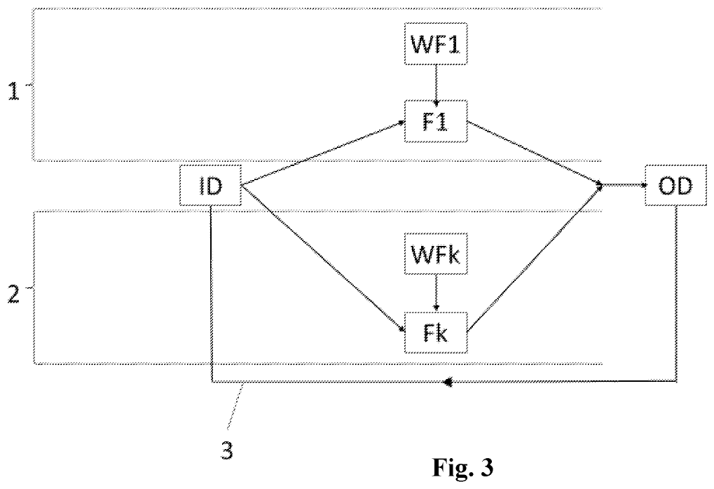

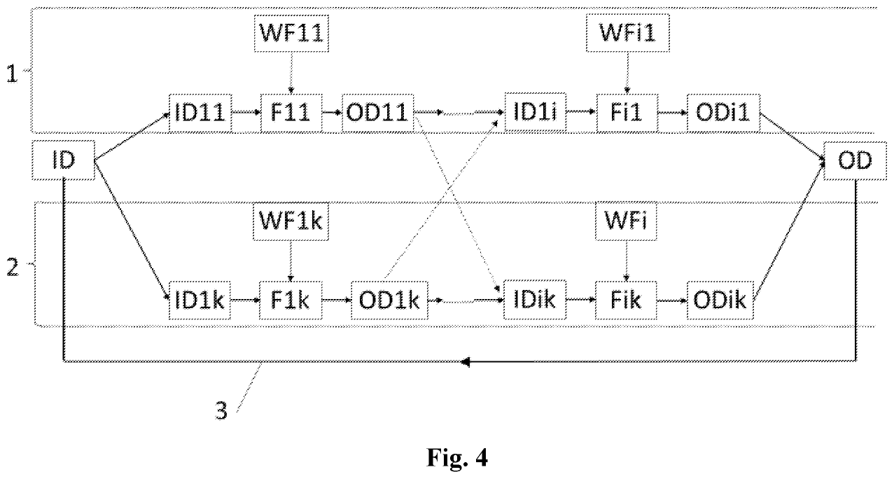

The subject matter is defined by the patent claims. FIG. 2, FIG. 3 and FIG. 4 as well as the descriptions of the figures illustrate the embodiments of the method according to the invention shown in the figures according to the first and/or the second and/or the third variant. The person skilled in the art is able to combine the figure descriptions of all figures with each other or a figure description for one figure with the general part of the description given above.

### DETAILED DESCRIPTION

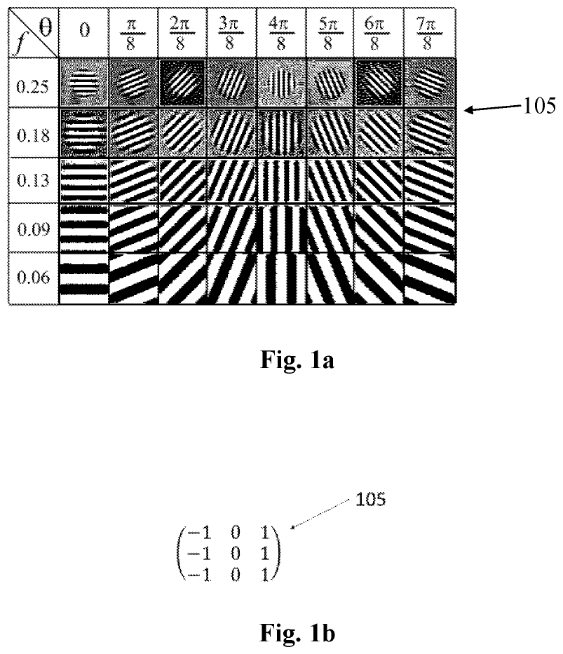

FIG. 1a illustrates an example of a filter criterion according to the background of the art (2D Gabor filter with orientation θ and frequency f), which filter criterion is applicable to a filter. This filter criterion or a filter comprising such a filter criterion can also be used in the first and/or second and/or third variant of the method according to the invention. In the example of a filter criterion shown in FIG. 1a, output data are determined from input data by superimposition with the filter comprising the filter criterion as a function of the conicity of the pixels. In addition to the filter criterion shown in FIG. 1a, other filter criteria according to common teaching can also be used. For example, a 2D filter (Prewitt filter) in the format 3·3·1 for detecting vertical data in a single-channel 2D image is shown in FIG. 1b.

FIG. 2 illustrates an embodiment of the method according to the invention according to the first and/or the second and/or the third variant for processing data in neural networks.

It is well known in the background of the art that the input data are analyzed using a number of i filters (i=1, 2, 3 . . . ). In this case, the input data are successively analyzed by means of the sequentially arranged filters, wherein each filter has a filter criterion. The filter criteria of the individual filters can be different in an advantageous manner.

The input data ID are received as first input data ID1 for analysis using the first filter F1, wherein the first result data OD1 are determined. The i−1-th result data ODi-1 arrive as the i-th input data Idi for analysis using the i-th filter Fi, wherein the i-th result data ODi are determined. The input data ID are thus analyzed using a chain of i filters, wherein the result data ODi determined last in the chain correspond to the result data OD of the filtering method step using the i filters.

A weighting factor WFi (i=1, 2, 3, . . . ) is associated with each filter Fi (i=1, 2, 3, . . . ). For example, a first weighting factor WF1 is associated with the first filter F1. The i-th weighting factor WFi (i=1, 2, 3, . . . ) is associated with the i-th filter Fi (i=1, 2, 3, . . . ). The mathematical association of a weighting factor WFi with a filter Fi can be such that the result data ODi (i=1, 2, 3, . . . ) determined by means of the filter Fi (i=1, 2, 3, . . . ) are multiplied by the respective weighting factor Wi (i=1, 2, 3, . . . ). The association of a weighting factor with a filter can also include a logic such that when the weighting factor Wi is equal to zero, the result data ODi have the value zero.

The line shown in FIG. 2 and identified by reference numeral 1 corresponds to a filtering method step. A filtering method step 1 can be repeated by feeding back the output data of a filtering method step as input data of the subsequent filtering method step. In an advantageous manner, the result data OD are stored in a memory before being fed back, which optional process is not shown in FIG. 2. The feeding back of the output data as input data for the subsequent filtering method step is represented by the arrow 2 in FIG. 2.

The embodiment of the method according to the invention described in FIG. 2 according to the first and/or the second and/or the third variant is characterized in that the number of filters Fi (i=1, 2, 3 . . . ) over the number of filtering method steps is unchanged. All filtering method steps therefore have a static number of filters for generating result data.

According to the background of the art, i=1, 2, 3 . . . has an amount adapted to the respective analysis problem; i varies with the particular analysis problem. The consequence of this is that, if the common teaching is applied exclusively, one method step—not the filtering method steps as shown in FIG. 2 by the reference numeral 3—can be repeated. The implementation of the common teaching is limited to a sequential arrangement of the filters F1 . . . Fi exclusively to form a filter chain.

The method according to the invention according to the first and/or the second and/or the third variant is characterized in that i has a static value. When the method according to the invention is used according to the first and/or the second variant, the static value is set to an analysis based on the principle of neural networks when the system is being taught. In contrast to the systematics of the common teaching briefly described above, which is based on the omission of filters which are not required, in the method according to the invention according to the first and/or the second variant it is provided that, while maintaining the static number of filters F1 . . . Fi, a weighting factor of zero or close to zero is associated with a filter which is not required.

The static number of filters to be applied has the effect that a filtering method step based on the application of a number of filters is repeatable. The repetitive filtering method steps can be carried out in an advantageous manner on a computer processor comprising ASCI modules.

As explained above, each filter Fi (i=1, 2, 3 . . . ) is associated with a weighting factor WFi (i=1, 2, 3 . . . ).

A weighting factor WFn of the weighting factors WFi (nϵi=1, 2, 3, . . . ) can assume a weighting factor value with the value zero. This has the effect that the filter Fn, with which filter Fn the weighting factor WFn with the value zero is associated, is preserved in terms of circuit arrangement and a corresponding analysis of the input data IDn is carried out, but the product of result data ODn and WFn assumes the value zero. The filter Fn therefore has no influence on the result data OD of the filtering method step. With reference to the above description of FIG. 2, the method according to the invention according to the first and/or the second and/or the third variant is characterized in that, while maintaining a static number of filters, the influence of a filter is set equal to zero via the associated weighting factor with the value zero.

A weighting factor WFn of the weighting factors Wi (nϵi=1, 2, 3, . . . ) can assume a non-zero weighting factor value. This has the effect that the filter Fn, with which filter Fn the weighting factor WFn with the non-zero value is associated, is preserved in terms of circuit arrangement and a corresponding analysis of the input data IDn is carried out, wherein the product of result data ODn and WFn assumes a value other than zero. The filter Fn thus has an influence on the result data OD of the filtering method step.

The person skilled in the art recognizes that in order to achieve a meaningful result, at least one weighting factor associated with a filter has different values in filtering method steps. The weighting factors WFi associated with the filters Fi can be determined by teaching a neural network under application of the common teaching. In contrast to the methods according to the background of the art in which methods according to the background of the art filters are omitted in an elaborate manner, in the method according to the invention according to the first and/or the second variant, all filters are present from in terms of circuit arrangement, wherein in an efficient manner, by setting the weighting factor WFi equal to zero or to non-zero, the respective filter FI has no influence or an influence on the result data of the respective filter.

FIG. 3 illustrates a further embodiment of the method according to the invention according to the first and/or the second and/or the third variant for processing data in neural networks. The input data ID are analyzed using a number of at least one filter Fk (k=1, 2, 3, . . . ) defining a filter criterion and generating result data OD in filtering method steps 1, 2,

whereby the result data OD, comprising result values, corresponding to the filter criterion are generated, wherein a weighting factor WFk can be associated with a filter Fk in each case.

The method according to the invention according to the first and/or the second and/or the third variant is characterized by a static number of k filters. The method shown in FIG. 3 can be carried out repeatedly—as shown by arrow 2—by feeding back the result data OD as input data ID. In particular, the repetitive filtering method steps can be carried out on a computer processor comprising ASCI modules.

The method according to the invention according to the first and/or the second and/or the third variant is characterized in that the input data ID are analyzed in parallel filtering method steps 1, 2. The result data OD can be summarized in a result matrix.

By feeding back the result data OD of the j-th method step as input data ID of the j+1-th method step, this embodiment of the method according to the invention can be repeated according to the first and/or the second and/or the third variant. The method according to the invention according to the first and/or the second and/or the third variant according to FIG. 3 can include the optional step of storing the result data OD of the j-th method step in a memory (not shown in FIG. 3) before the result data OD are fed back to carry out the j+1-th method step.

In analogy to the embodiment described in the figure description for FIG. 2, a weighting factor WFk (k=1, 2, 3 . . . ) is also associated with a filter Fk in the embodiment of the method according to the invention according to the first and/or the second and/or the third variant shown in FIG. 3, whereby the effects and advantages mentioned in the figure description for FIG. 2 and in the general part of the description can be achieved.

In summary, it is once again stated that the filters can be switched on and off via the weighting factors while maintaining the static number of filters. The method shown in FIG. 3 is characterized in that the number k of filters is constant.

FIG. 4 illustrates the combination of the first embodiment and the second embodiment of the method according to the invention according to the first and/or the second variant. The first embodiment and the second embodiment can be carried out as separate methods independent of one another, as above with reference to the description of the figures for FIG. 2 and for FIG. 3.

Described in general terms, input data ID are generated by means of filters having a filter criterion, which result data OD correspond to the filter criterion. The method can be repeated by feeding back the OD of the j-th method step as input data of the j+1-th method step.

The input data are analyzed in k filtering method steps 1, 2 running in parallel, with k assuming a static value when the method according to the invention is carried out according to the first and/or the second variant. The filtering method steps 1, 2 comprise a number of i filters, wherein i has a static value. The method according to the invention according to the first and/or the second variant is characterized in that a filtering method step 1, 2 has the same number of i, k filters (i, k=1, 2, 3 . . . ) in all j repetitions of a filtering method step 1, 2.

In analogy to the embodiment of the method according to the invention described in the figure description for FIG. 2 according to the first and/or the second variant, each filter Fik (i, k=1, 2, 3 . . . ) has a weighting factor WFik (i, k=1, 2, 3 . . . ) associated, wherein the influence of a filter Fik (i, k=1, 2, 3 . . . ) on the result data ODj of the j-th method step can be defined by the weighting factors Wik (i, k=1, 2, 3 . . . ). A weighting factor Wik can be associated with a value of zero or a value close to zero, so that the filter Fik (i, k=1, 2, 3 . . . ) has no influence on the result data ODj of the j-th method step while maintaining this filter Fik (i, k=1, 2, 3 . . . ).

The weighting factors Wik can be determined by teaching a neural network using common teaching. The person skilled in the art recognizes that in order to obtain a meaningful result, at least one weighting factor associated with a filter has different values in the filtering method steps.

By selecting the weighting factors Wik, which are associated with the filters Fik, according to the above description equal to zero or non-zero, the number of filters can remain the same in all repetitions of the embodiment of the method according to the invention according to the first and/or the second variant in the individual filtering method steps 1, 2 shown in FIG. 4. Likewise, the number of filtering method steps 1, 2 running in parallel can remain the same. Because of the advantageous rigidity of the number of filters Fik (i, k=1, 2, 3, . . . ), the method disclosed herein for analyzing data using neural networks can be carried out on rigidly structured processors.

The person skilled in the art can reduce the dimension of the result matrix using reduction methods known from the background of the art. The person skilled in the art can, for example, use max-pooling methods, methods with averaging, etc.

FIG. 4 shows a very simplified representation of the analysis of data using the method according to the invention according to the first and/or the second and/or the third variant. In particular, the serial and parallel arrangement of the filters is shown in a very simplified manner with reference to FIG. 2 and FIG. 3. The person skilled in the art knows that relationships outside of the method steps arranged in parallel or in series are possible with reference to the current methods of CNN. This is shown in FIG. 4 using the dashed arrows between the parallel method steps 1, 2. The method shown in a simplified, schematic manner in FIG. 4 can be expanded by incorporating the common teaching in regard to CNN.

In the above description of the figures for FIGS. 2, 3, 4, an unspecified number i, k of filters is mentioned. The number of filters applicable when processing input data are determined by the properties of the computer processor or processors.

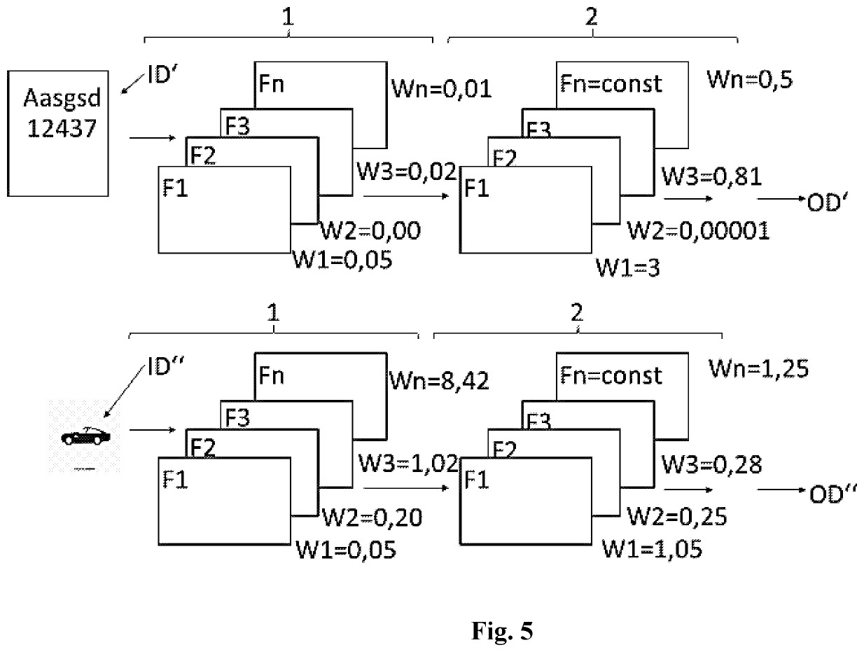

FIG. 5 illustrates the analysis of data in a form unified by the number of filters.

FIG. 5 comprises an eye chart with letters and numbers as first input data ID′. The contents of the eye chart are of no further relevance to the discussion of the invention disclosed herein, other than that the eye chart includes, for example, letters and numbers.

FIG. 5 comprises an image of a car as second input values ID2. The image of the car can, for example, have been recorded by a camera of another car, which other car includes a self-steering system. The image of the car shown as the second input value ID″ in FIG. 2 can also be an image from a surveillance camera.

As explained in FIG. 5, the first input data are analyzed by means of n filters in a first filtering method step 1. The number of filters is specified (the number n is constant with n=1, 2, 3 . . . ). A weighting factor is associated with each filter, wherein each weighting factor has a weighting factor value for analysis of the first input data.

The first weighting factor W1 associated with the first filter F2 has a weighting factor value of W1=0.05, for example.

The second weighting factor value W2 associated with the second filter F2 has a weighting factor value of W2=0.0. By setting the second weighting factor value W2 equal to zero, the influence of the second filter F2 on the result obtained is suppressed during the analysis of the eye chart in the first filtering method step 1.

In the second filtering method step, a number of n filters are used again. The number of n filters, which n filters are used in the first filtering method step 1, corresponds to the number of n filters, which are used in the second filtering method step 2.

In the second filtering method step 2, the influence of the filter Fn (n=constant, n=1, 2, 3 . . . ) is also determined by the weighting factors, wherein a weighting factor is associated with a filter Fn. The weighting factor W2 associated with the second filter F2 includes a weighting factor value of W2=00001, which second weighting factor value has a value almost equal to zero in the context of the analysis of the eye chart. The second filter F2 of the second filtering method step thus has no significant influence on the analysis of the eye chart as the first input data ID′.

The first filtering method step 1 and the second filtering method step 2 can be carried out in the application of the method according to the invention shown in FIG. 5 according to the first and/or second variant by means of a computer processor comprising an ASIC component. This does not rule out that this method can also be carried out with a different processor. Furthermore, the analysis in the first filtering method step 1 can be carried out with a first processor and the analysis in the second filtering method step 2 can be carried out with a second processor.

FIG. 5 also illustrates the analysis of image data as second input values ID″, which second input data ID″ are obtained by another device and which second input data ID″ describe a fundamentally different situation.

The method according to the invention according to the first and/or the second and/or the third variant can be characterized in that the constant number n of filters for analyzing the first input values ID′ corresponds to the constant number n of filters for analyzing the second input values ID″. This is possible because the influence of the filters on the result data is controlled via the weighting factors associated with the filters when the method according to the invention is carried out according to the first and/or the second and/or the third variant.

The person skilled in the art can combine the method shown in FIG. 5 with the sub-methods of mathematical convolution and/or a sub-method for reducing the amount of data (“subsampling”) and/or a sub-method for discarding superfluous information (“pooling”) and/or a sub-method for classification (“fully-connected layer”) known from the background of the art for processing data.

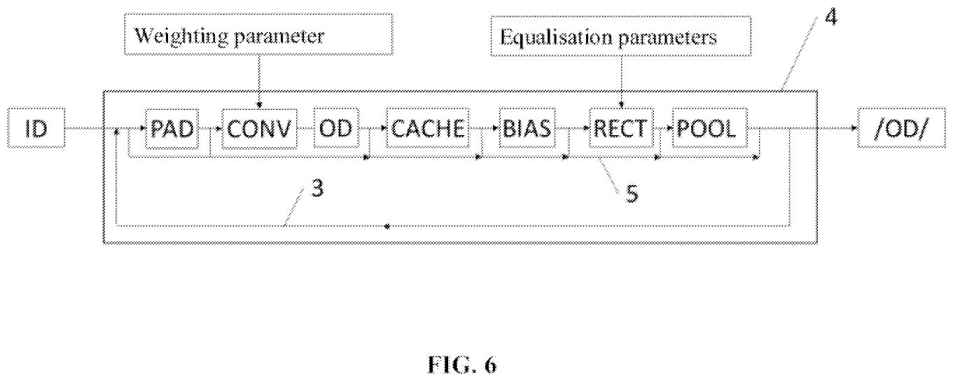

FIG. 6 illustrates a further embodiment of the method according to the first and/or the second and/or the third variant, wherein the method according to the invention according to the first and/or the second and/or the third variant is supplemented by at least one further method step. The at least one further method step can be selected from the group of further method steps described below and known from the background of the art, which can be combined with methods of neural networks known from the background of the art: padding PAD, buffer memory CACHE, equalization BIAS, rectification RECT (application of a non-linear activation function) and pooling POOL. The omission of a selected further method step has no influence on the effects that can be achieved by the other further method steps. The omission of a selected further method step only has an effect on the result data. The further method steps mentioned can thus be combined in any manner. The latter is not shown in FIG. 6; FIG. 6 illustrates a possible supplementation of the method according to the invention under discussion according to the first and/or the second and/or the third variant with the further method steps.

The combination of the further method steps with the method according to the invention according to the first and/or the second variant has the special effect that an embodiment of a method comprising the method according to the invention according to the first and/or the second variant and the further method steps without intermediate storage of determined values is feasible. This is achieved by the constant number of filters. With regard to the computing unit used, the constant number of filters allows the clearly defined interconnection of the logic implemented in the computing unit.

The person skilled in the art is also able to combine the method according to the invention according to the first and/or the second and/or the third variant with further method steps not listed here.

FIG. 6 summarizes the method according to the invention according to the first and/or the second variant and the further method steps by means of the rectangle 4, which method according to the invention according to the first and/or the second variant and which further method steps are preferably executed on a computing unit when all further method steps are selected.

The input data ID can be predetermined data and/or data that can be determined by a sensor. The origin of the data has no influence on the implementation of the method illustrated in FIG. 6. Merely to facilitate the understanding of the following description and thus in no way restrictive, it is assumed that the input data ID are determined by means of an image sensor and have a matrix format of 640×480, taking into account the properties of the black/white image sensor not discussed herein.

The input data ID are fed to the padding method step PAD as a further method step.

The input data ID are fed to a so-called method step CONV, in which method step CONV the incoming data ID are processed using the teaching of CNN with a constant number of filters according to the above description and thus using the method according to the invention described above according to the first and/or the second variant.

The weighting factors can be fed to the computer processor executing the method step CONV. For this purpose, the weighting factors are stored in a persistent memory. The arrangement of the memory for storing the weighting factors per se has no influence on the implementation of the method illustrated in FIG. 6 or of the method according to the invention according to the first and/or the second variant. The arrangement of the memory is merely an issue associated with the design of the components.

The result values OD have the format 640×480×4 (the input data ID is a grey value image) if, for example, four filters are used in the convolutional layer CONV for processing the data. In a manner analogous to this, the result values OD can have the format 640×480×16 (the input data ID is a grey value image) when sixteen filters are used.

The format of the result values given as an example is independent of the weighting factors. If a weighting factor has the value zero, then the result values calculated using this weighting factor are zero. Thus, only the content of the result data OD is dependent on the weighting factors.

The result data OD are supplied to a buffer memory CACHE, which buffer memory CACHE is designed according to the background of the art in the logic of the computing unit. The incoming result data OD are summed up in the buffer memory using methods according to the background of the art. The buffer memory CACHE is preferably not a RAM memory, which would be possible with reference to common teaching, but would be less advantageous in view of the method discussed here. Using techniques according to the background of the art and with reference to the example above, the 640×480×4 result data are summed into a 640×480×1 matrix format.

The summed up data are fed from the buffer memory CACHE to an equalization step BIAS, in which equalization step BIAS the data are equalized using the common teaching, then to a rectification method step RECT and finally to a pooling method step POOL. The method steps CACHE, BIAS, RECT, POOL are known from the background of the art.

The equalization parameters for carrying out the equalization step can be stored outside of the computing unit symbolized by the rectangle 4. According to common teaching, the rectification process is also known as activation, in which rectification process or in which activation processes known according to the background of the art, such as the ReLu method, are used.

The further result values /OD/ are defined as the result values which are determined from the result value OD from the processing of the data using the CNN teaching with a constant number of filters—thus using the method according to the invention described above according to the first and/or the second variant—and the application of a further method step from the group of method steps CACHE, BIAS, RECT, POOL.

The method according to the invention according to the first and/or the second and/or the third variant and the further method steps, which are summarized by the rectangle 4, can be repeated i-fold (i=1, 2, 3 . . . ), as shown by the arrow 3 symbolizing the feedback of the data. It is also conceivable that the further result values /OD/ are supplied to a further computing unit comprising the method according to the invention according to the first and/or the second and/or the third variant and at least one further method step, which is not shown in FIG. 6.

The method according to the invention according to the first and/or the second variant—represented by the method step CONV in FIG. 6—and the further method steps CACHE, BIAS, RECT, POOL are preferably carried out on a computing unit. For the selection of at least one further method step and the non-performance or omission of other further method steps as well as the performance/non-performance of the method according to the invention described above according to the first and/or the second variant in an i-th method step, the computing unit comprises a corresponding circuit 5. The person skilled in the art is undoubtedly capable of designing such a computing unit with such a circuit 5. The circuit 5 also allows result values to be read out while omitting a further method step.

The summation of the result values OD obtained from the method according to the invention according to the first and/or the second variant, carried out by the further method step CACHE, has the effect that the required memory can be reduced.

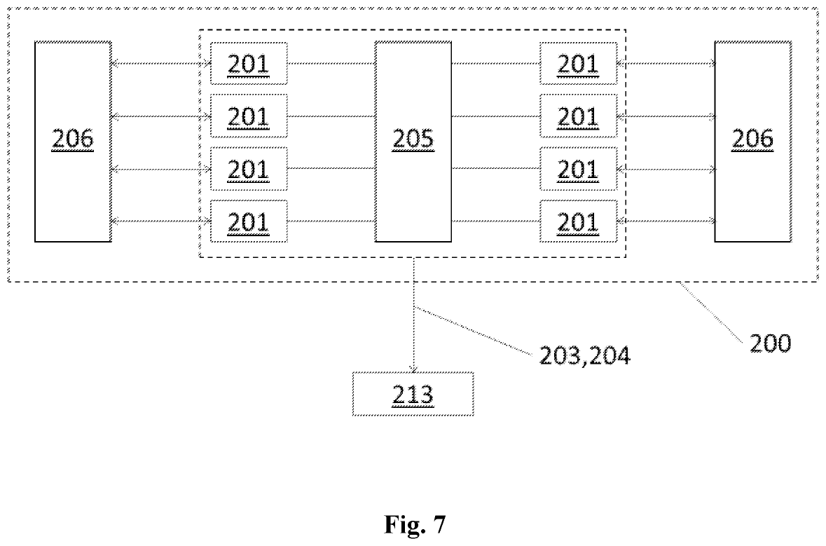

FIG. 7 shows a logic module 200 according to the invention, in particular an ASIC, in which electronic circuit arrangements for performing neural network calculations for a neural network 100 with a plurality of first layers 101, in particular for carrying out a method according to the invention, are permanently specified (i.e. unchangeable after production of the logic module).

The logic module 200 has a signal input 203 for supplying input (for example from an external CPU 213) for the neural network 100 and a signal output 204 for delivering the output of the neural network 100.

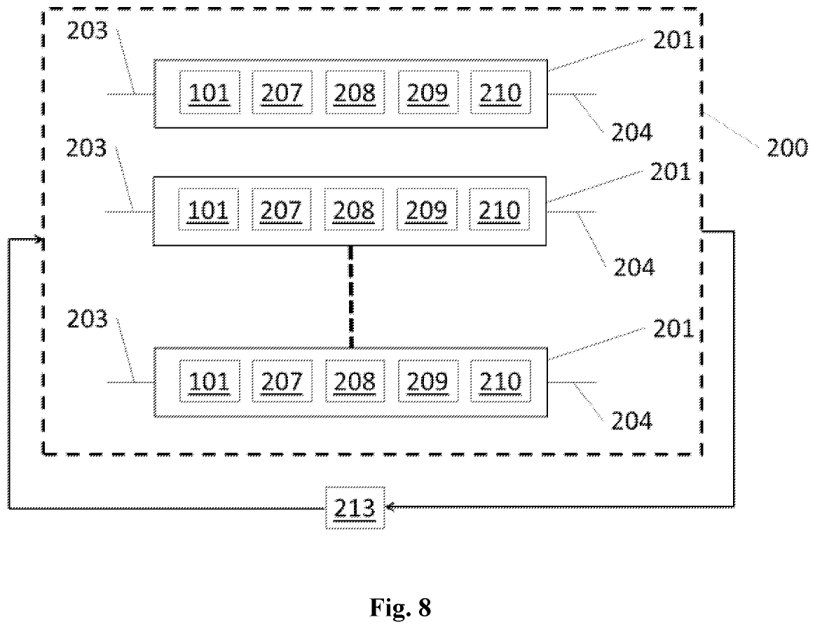

A plurality (here exemplarily six) of first layer circuit arrangements 201 each representing a first layer 101 of the neural network 100 is provided, wherein each first layer circuit arrangement 201 has at least one signal input for receiving input data and at least one signal output for outputting result data and wherein each first layer circuit arrangement 201 has at least one first layer 101 (cf. FIG. 8) in which, in each case in one or more channels, a number of result data can be generated from input data having an input data size per channel using a number of filters 105 associated with the at least one first layer 101 by linear arithmetic operations, wherein receptive fields of the filters 105 associated with the at least one first layer 101 are smaller than the input data size per channel of the at least one first layer 101, and wherein the filters 105 perform the linear arithmetic operation per channel at different points of the input data.

All first layer circuit arrangements 201 have the same number of filters 105, which are associated with the at least one first layer 101, and in each of the at least one first layers 101 of each first layer circuit arrangement 201, each of the filters 105 associated with a respective first layer 101 is used for linear arithmetic operations.

A weighting factor is associated with each filter 105, which determines the extent to which the result of the arithmetic operations performed by the respective filter 105 at the different points of the input data is taken into account when generating the result data.

The logic module 200 has an output circuit arrangement (not shown) connected to the signal output 204.

A scheduler circuit arrangement 205, which is in data communication with the plurality of first layer circuit arrangements 201, is designed to define a network architecture of the neural network 100 in order to specify, according to a changeable specification, the order in which a data flow is conducted from the signal input 203 of the logic module 200 to the individual first layer circuit arrangements 201, between the individual first layer circuit arrangements 201 and from the individual first layer circuit arrangements 201 to the output circuit arrangement.

Two second layer circuit arrangements 202 are shown by way of example in FIG. 7, which are tightly connected to one another and one of which can be connected to an output circuit arrangement or can be designed as such.

The result of the network calculations can be supplied to an external CPU 213.

FIG. 8 shows an example of the structure of the various first layer circuit arrangements 201 in detail for the logic module 200 shown in FIG. 7.

Here, each first layer circuit arrangement 201 has the same structure. In particular, of course, each first layer circuit arrangement 201 (more precisely: the first layer 101 contained in it) has the same number of filters 105 as all other first layer circuit arrangements 201.

Each first layer circuit arrangement has a signal input 203 and a signal output 204. The scheduler circuit arrangement 205 (not shown here) can be used to determine how the signal inputs 203 and the signal outputs 204 of the individual first layer circuit arrangements 204 are connected to one another.

Each first layer circuit arrangement 201 represents a first layer 101 of the neural network 100 in the sense that each first layer circuit arrangement 201 has its functionality in operation.

Various functional modules that are present here are shown as examples (known per se because they correspond to the background of the art):
a cache memory system 207
a bias module 208 for removing a bias that may be present
a rectification module 209 for carrying out a rectification process (also known as applying a non-linear activation function)
a pooling module 210 for carrying out a pooling and/or downsampling method
a padding module 211 for carrying out a padding method

It is not always necessary to use all the functional modules in every first layer circuit arrangement 201; instead, it can be specified for each of the first layer circuit arrangements 201 which functional modules are used in it. This can preferably be handled by the scheduler circuit arrangement 205.

It can be provided that the scheduler circuit arrangement 205 defines a network architecture in such a manner that a data flow is conducted from at least one functional module of a first layer circuit arrangement 201 directly to at least one functional module of another first layer circuit arrangement 201.

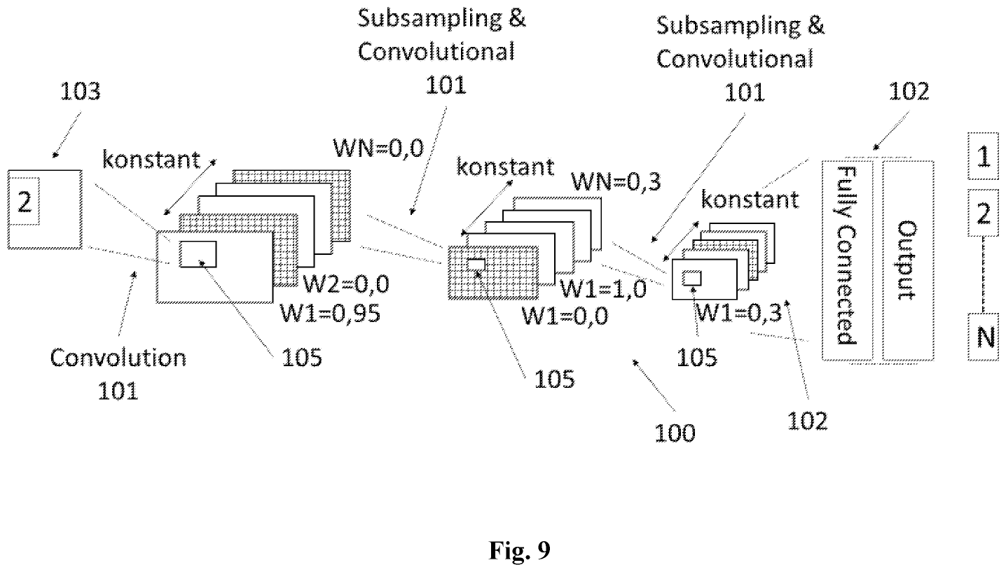

FIG. 9 shows a possible architecture of a trained neural network 100 in inference operation in the form of a CNN, through which a method according to the second variant of the invention can be executed and which can be permanently stored in a logic module 200 according to the invention.

The neural network 100 has an input layer 103 via which the neural network 100 can be supplied with an input (the number two here, by way of example). By way of example, three first layers 101 are provided, in which result data are calculated by means of filters 105 using convolutions and are each supplied to a subsequent layer 101, 102. It is important for the invention that each first layer 101 has the same number of filters 105 (here, for example, five filters 105) and all of the filters 105 in each first layer 101 are also used. In this example, the training of the neural network 100 has shown that in the first layer 101 shown on the far left, the results of the arithmetic operations of two filters 105 are not taken into account in the generation of the result data (their weighting factors are equal to zero), while in the first layer 101 shown in the middle and on the right, one filter 105 is applied in each case, but without having any influence on the generation of the result data. The training of the neural network 100 has also shown that the results of the arithmetic operations of those filters 105 whose weighting factors are non-zero are weighted differently, which results from the different numerical values of the weighting factors given by way of example.

In each first layer 101, a non-linear activation function is used to generate result data in the form of activation data (this process, also known as a rectification process, is not shown because it corresponds to the background of the art anyway).

The result data (more precisely: result data in the form of activation data) of the last first layer 101 as viewed computationally are fed to two tightly connected second layers 102, of which the second layer 102 shown on the right is configured as an output layer 104.

Apart from the constant number of filters 105 in the individual first layers 101, the neural network 100 shown in FIG. 9 corresponds to the background of the art.

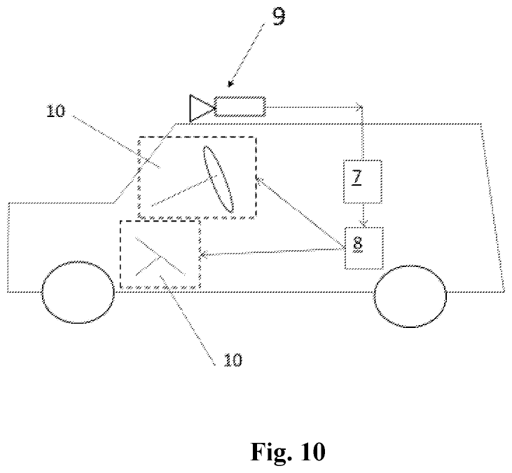

FIG. 10 shows a device 6 according to the invention in the form of a vehicle with at least one logic module 200 according to the invention, wherein signals can be supplied to the at least one logic module 200 as input for the neural network calculations via at least one signal input 203 by at least one signal generating device 9 arranged on or in the vehicle, and wherein the at least one logic module 200 has at least one signal output 204 for communication with a control or regulating device 8 of the vehicle or for the output of control commands to at least one actuator 10 of the vehicle (not shown).

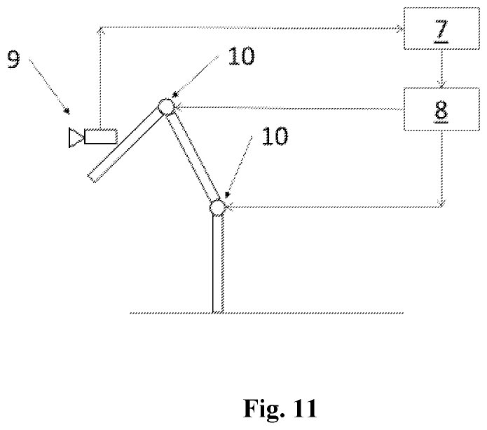

FIG. 11 shows a device 6 according to the invention in the form of a robot with at least one logic module 200 according to the invention, wherein signals can be supplied to the at least one logic module 200 as input for the neural network calculations via at least one signal input 203 by at least one signal generating device 9 arranged on or in the robot, and wherein the at least one logic module 200 has at least one signal output 204 for communication with a control or regulating device 8 of the robot or for the output of control commands to at least one actuator 10 (for example a servomotor or manipulation device) of the robot (not shown).

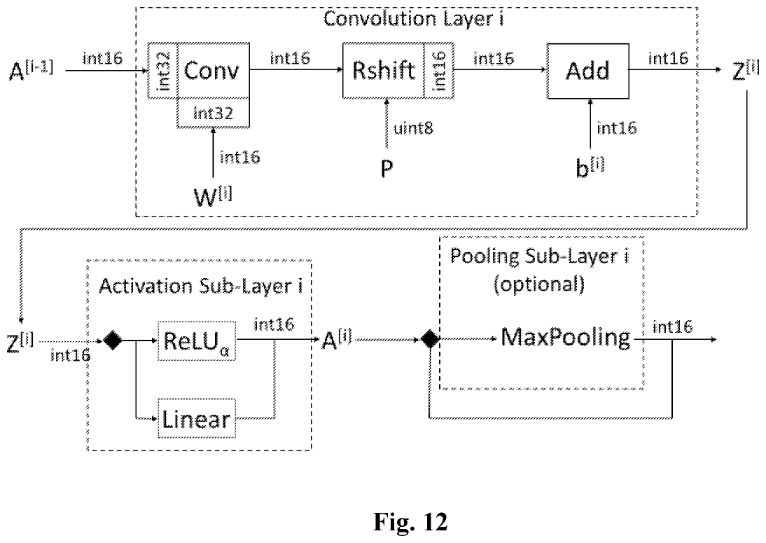

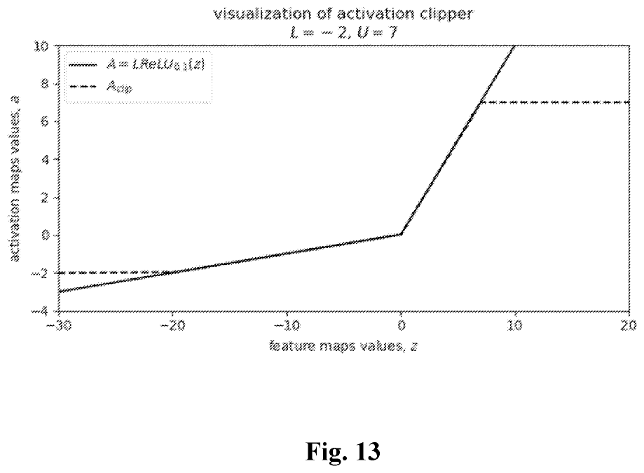

FIGS. 12 to 14 show a method according to the third variant of the invention, in which an activation clipping (in this case in combination with a quantization of the neural network 100) is used. The neural network 100 is used, for example, in the field of computer vision with classification of objects in an image or video stream.

FIG. 12 shows an i-th first layer 101 of a neural network 100, with a convolutional layer CONV, a rectification layer RECT (in which the non-linear activation function is applied) and an optional pooling layer POOL. In the following the occurring matrices and operators are explained:

### Matrices:

A^{[i-1]} or A^{[i]} denotes the entirety of the activation result data (activation map) of the previous (i−1-th) layer 101 or the present (i-th) layer 101, which is present here in data format int16 (A^{[0]} corresponds to the RGB matrix of the input image). Correspondingly, E^{[i-1]} or E^{[i]} denotes the entirety of the result data (feature map) of the previous (i−1-th) layer 101 or of the present (i-th) layer 101

The parameter P (a natural number) denotes a scaling exponent for a quantization, which is performed according to the formula Xᵢₙₜ^{[i]}=castᵢₙₜ(X_{float}·2^{P}) (Gl.1). A value of P=8 is preferred.

A weighting matrix of the convolution operation, whose entries represent weighting factors, is denoted by W^{[i]}, which is quantized according to Eq. 1.

A bias vector of the convolution is denoted by b^{[i]}, the quantization is performed according to Eq. 1.

Operators:

The operator “Rshift” represents a bit shifter, since after convolution of the quantized matrices (A^{[i-1]}*W^{[i]}) a normalization is required, in which the result is shifted to the right by P digits, as shown in the following equation: norm(A^{[i-1]}*W^{[i]})=Rshift(A^{[i-1]}*W^{[i]}) (Eq. 2). The operation “Add” adds the bias vector. The function ReLU_{α} represents the non-linear activation function, where α=0 results in the ReLU function and α≠0 results in a LReLU function.

“Linear” denotes an optional linear activation function.

“MaxPooling” denotes a pooling operator executed here as MaxPooling by way of example.

The casting function “cast” casts the input to the specified bit width, e.g. castᵢₙₜ₃₂(0539)=00000539 or castᵢₙₜ₃₂(FAC6)=FFFFFAC7.

With the “Activation Clipper” (clipping function), the value range of the activation result data is restricted from a first image area B1 to a real subset in the form of a second image area B2, wherein the “clipping function” used can be defined as follows (Eq. 3):

$$clip ( x , L , U ) = \{ \begin{matrix}x , & x ∈ [ L , U ] \\ L , & x < L \\ U , & x > U\end{matrix} \\ {A}_{clip} = [ clip ( {a}_{k} , L , U ) ) ] , ∀ {a}_{k} ∈ {A}^{[ i ]} ( Activation Map )$$

FIG. 13 shows an example of a non-linear activation function in the form of LReLU_{0.1} (z), which was clipped with the parameters with L=−2 and U=7. Optimal values are e.g. (in floating number arithmetic): L_{float}=−2 and U_{float}=14-2⁻⁴=13.9375 because the full bit width of the data type uint8 is used in this way. Scaling to integer arithmetic results in e.g. L=castᵢₙₜ₁₆(L_{float}·2^{P})=−512 and castᵢₙₜ₁₆(U_{float}·2^{P})=3568.

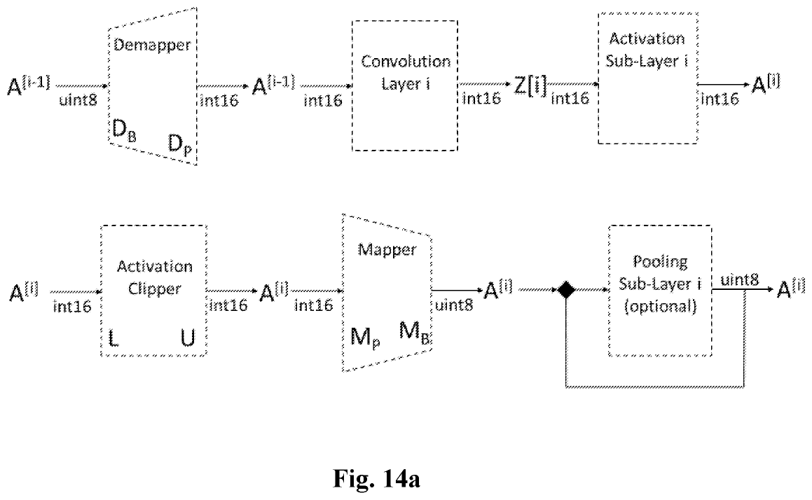

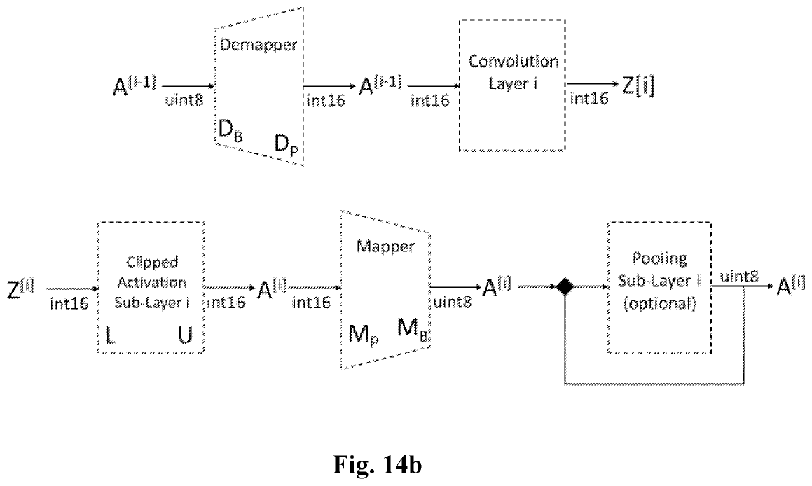

The exemplary embodiments in FIGS. 14a and 14b differ from that in FIG. 12 in that optional additional mapping and demapping methods are shown. In the exemplary embodiment in FIG. 14a, clipping is provided as a separate step from activation. In the exemplary embodiment in FIG. 14b, on the other hand, activation takes place with a clipped activation function (in a single step).

The mapping operator maps the clipped values A_{clip} of the activation result data to the data type uint8 (with value range [0, 255]). In a first step, a mapping bias M_{B} to A_{clip} is counted, which is selected in such a manner that the minimum value of the clipped activation result data is mapped to 0 (i.e M_{B}=−L). In a second step, the matrix A_{clip}+M_{B} according to the mapping power M_{P} is shifted rightward, wherein the following applies (Eq. 4):

$${M}_{P} \geq ⌈ ld ( \frac{U + \vert {M}_{B} \vert}{255} ) ⌉$$

For the above example with L=−512 and U=3568, the result is e.g. M_{P}=4.

The mapper can be summarized as follows:

Aₘₐₚ=[map(αₖ,M_{B},M_{P})]=[Rshift(αₖ+M_{B},M_{P})], ∀αₖϵA_{clip}

Aᵤₙᵢₜ₈=castᵤₙᵢₜ₈(Aₘₐₚ).

After running through the i−1-th first layer 101, the uint8 activation maps A^{[i-1]}ᵤᵢₙₜ₈ are written to the memory and read out for the i-th layer 101. For the execution of the linear arithmetic operation (here: convolution) A^{[i-1]}ᵤᵢₙₜ₈ is mapped back to the data type int16 (demapping, decompression). Similar to the mapping operation, two parameters are required for the demapping method: Demapping power D_{P} and demapping bias D_{B}. The demapping mapping function can thus be defined as follows:

A_{demap}=[demap(αₖ,D_{B},D_{P}))]=[Lshift(αₖ,D_{P})−D_{B})], ∀αₖϵcastᵢₙₜ₁₆(Aᵤᵢₙₜ₈)

The previously used mapping power is selected as demapping power: D_{P}=M_{P}. For the demapping bias D_{B}, the first natural choice would be to use the mapping bias. However, a closer look at the mapping and demapping losses, also referred to as quantization noise Q, reveals that Q is not mean-free for D_{B}=M_{B}. This results in a gain effect in the error propagation, which leads to larger deviations between the floating number model of the neural network 100 and the quantized version. In order to obtain a mean-free quantization noise, the demapping power is therefore chosen as follows: D_{B}=M_{B}−2^{M}^{_{P}}⁻¹.

According to the background of the art, such analysis methods are characterized by a fluctuating number of filters between the filtering method steps. This is particularly disadvantageous when dimensioning the computer processors of the computers, since the number of filters is a changeable variable over the course of the method steps. Computer processors of this type cannot be implemented as ASIC modules, but only by general processor units with sequential processing of the operations with a sufficiently dimensioned number of inputs and outputs.

The method according to the invention according to the first, second and third variants has the particular object of designing the method of analyzing data using neural networks in such a manner that they can be processed by computer processors comprising ASIC components (ASIC stands for application-specific integrated circuit) while making use of the advantageous properties of these components.

The method according to the invention according to the first, second and third variant also has the particular object of processing dynamic data in real time in an efficient manner.

Logic modules in the form of ASIC modules are distinguished by the fact that the function of an ASIC can no longer be changed after it has been manufactured, which is why the manufacturing costs of ASIC modules are generally low with high one-off costs for development. ASIC modules are created according to customer requirements with defined fixed interconnections and are normally only supplied to those specific customers.

Alternative logic modules are called free programmable gate arrays, or FPGAs for short, but FPGAs are much more expensive and therefore unsuitable for high volumes of components. FPGA components are freely programmable.

According to the invention, this is achieved by the method according to the invention according to the first and/or the second and/or the third variant.

The first variant of the method according to the invention is characterized in that the number of filters in the method steps is constant.

The method according to the invention according to the first variant is characterized by a static number of filters in each method step. When performing a filtering method step, the number of filters is equal to the number of filters used in a previous filtering method step.

The method according to the invention according to the first variant thus represents a simplification compared to the aforementioned methods according to common teaching, since the process of recognizing and classifying the non-relevant filters is omitted. The fixed number of filters also provides the advantage that the fixed number of filters represents a constant variable. The duration of the computing processes does not depend on a variable number of filters but on the constant number of filters and can therefore be planned.

The method according to the invention according to the first, second and third variants can be carried out using computer processors. The method according to the invention according to the first, second and third variant can be carried out in particular by means of computer processors comprising ASIC modules.

The fixed number of filters provides the further advantage that the method according to the invention according to the first and/or the second variant can be extended by the further filters classified as non-relevant during the teaching of the CNN because of the availability of all filters, which will be explained below with reference to a particular embodiment of the method according to the invention according to the first and/or the second variant. The method according to the invention according to the first and/or the second variant can thus be better adapted to a changing situation in comparison to the methods according to the background of the art.

The method discussed here according to the first variant can be carried out using sequentially arranged filters, with the individual filtering method steps taking place sequentially. Because of the constant number of filters, the method according to the invention according to the first variant is characterized in that the number of filters when carrying out a filtering method step is equal to the number of filters used in a previous filtering method step.

The individual filtering method steps can be carried out with a computer processor while storing a result of the individual filtering method steps. The individual filtering method steps can also be carried out with a single processor each.

The method disclosed here can be carried out by means of filters arranged in parallel, with the individual filtering method steps taking place in parallel. The individual filtering method steps can in turn be carried out using a computer processor. Each individual filtering method step can also be carried out by individual processors.

The terms “sequentially” and “parallel” used above can refer to a temporal arrangement and a spatial arrangement.

The combination of a sequential arrangement and a parallel arrangement of the filters is possible.

The method according to the invention according to the first and/or the second variant is characterized in that because the number of filters is constant over the number of method steps, the computing effort required to carry out the method according to the invention according to the first and/or the second variant, such as CPU utilization or memory requirements can be normalized in the individual method steps. The computing effort required for the individual method steps can be described by a mathematical function. The computing effort can, in particular, be constant over the individual method steps. This normalization of the method steps and/or the possibility of describing the computing effort using a mathematical function also has the effect that faults in a device for carrying out the method according to the invention are easily recognizable according to the first and/or the second variant.

The method according to the invention according to the first and/or the second and/or the third variant can be characterized in that a weighting factor is zero, wherein a weighting factor can be present in a form known from the background of the art. The method according to the invention according to the first and/or the second and/or the third variant is not based on a new definition of the weighting factors.

The weighting factor is linked to the respective filter in such a manner that if the weighting factor is equal to zero, the result determined using the respective filter is also equal to zero. Therefore, the filter with which a weighting factor equal to zero is associated, has no influence on the result data, which result data are generated using a plurality of filters.

The weighting factor associated with a filter can be linked to the filter by a mathematical operation or by a logic. The mathematical operation can be, for example, a multiplication of filter criterion and weighting factor, so that if the filter criterion and a weighting factor are multiplied by zero, the result that can be obtained using this filter is equal to zero.

The method according to the invention according to the first and/or the second and/or the third variant is characterized at most by the fact that all the filters are always present in terms of circuit arrangement. Merely the influence of the filters is controlled via the weighting factors.

In contrast to methods according to common teaching, the method according to the invention according to the first and/or the second and/or the third variant is based on a rigid structure and is therefore repeatable. The method according to the invention according to the first and/or the second and/or the third variant can be carried out on a microchip with rigid and therefore unchangeable properties.

The weighting factor can be non-zero with reference to common teaching. A non-zero weighting factor has an influence on the result with reference to the provisions of accuracy stated below.

The weighting factor can be equal to one with reference to common teaching.

By specifying a non-zero weighting factor, the influence of the respective filter on the result data can be defined in analogy to common teaching.

By specifying a weighting factor equal to one or a value close to one, the influence of the respective filter on the result data alone or in comparison to other weighting factors can remain unscaled or almost unscaled.

The invention can also include a weighting factor having a value close to zero and thus that filter having almost no influence on the result data. The person skilled in the art can, while tolerating an error, set the weighting factors associated with those filters, which filters are not intended to have any influence on the result data, to be close to zero and thus non-zero. The resulting error can be determined and reduced using methods according to the background of the art. If necessary, the methods according to the background of the art mentioned at the outset should be applied analogously to assess the influence of a filter on the result.

The method according to the invention according to the first and/or the second and/or the third variant can provide for the use of filters in the analysis of data. According to common teaching, the analysis of data requires the previous process of teaching the CNN including the determination of these filters and/or weighting factors, the weighting factors being associated with the filters.

The method according to the invention according to the first and/or the second and/or the third variant can be characterized in that these filters with filter properties, which filters have a non-relevant influence on the result data during the process of teaching the CNN, receive a weighting factor of zero or close to zero. In one possible embodiment of the method according to the invention, according to the first and/or the second variant, these filters cannot be deleted during the teaching process.

The method according to the invention according to the first and/or the second and/or the third variant can be characterized in that, when using the method according to the invention according to the first and/or the second and/or the third variant, the influence of the filters on the final result is further reviewed.

Such a review can have the result that a filter, which filter is classified as non-relevant for the result data during teaching and is given a weighting factor equal to zero, is given a weighting factor unequal to zero after the aforementioned review. Such a review can also have the result that a filter, which filter is classified as relevant during teaching and is given a non-zero weighting factor, is given a weighting factor equal to zero after the aforementioned review. These adaptation processes are reversible, in contrast to the methods of the background of the art, which methods only allow a filter to be deleted. If necessary, these adaptation processes will only be carried out after they have been reviewed by a person skilled in the art.

In addition to the analysis of input data mentioned, a possible application of the method according to the invention according to the first and/or the second and/or the third variant is to determine the influence of a filter or the influence of a plurality of filters in a very efficient manner. This review can be performed such that selected weighting factors from a plurality of filters are set equal to or close to zero. If an ASCI processor comprises, for example, 2ⁿ(n=1, 2, 3 . . . ; for example, eight with n=3) filters with 2ⁿ weighting factors associated with the filters as a computing unit for advantageously carrying out the method according to the invention according to the first and/or the second variant, the influence of these filters on the final result can be determined by setting 2ⁿ weighting factors equal to zero. In an iterative process, the influence of the filters from a large number of filters—here, for example, eight filters—can be reviewed in a very efficient manner. The method according to the invention according to the first and/or the second and/or the third variant can be characterized in that a number of 2ⁿ filters is determined from a plurality of filters, the number of 2ⁿ filters having no significant influence on the result value. In contrast to the method according to the invention according to the first and/or the second and/or the third variant, the aforementioned method for determining an optimal number of filters (known to the person skilled in the art as “pruning” or “spiking”) is based on filters having no significant influence on the result value. The method according to the invention according to the first variant is thus a further development of the known methods (for example “pruning” or “spiking”).

The method according to the invention according to the first and/or the second and/or the third variant is characterized in that an analysis of incoming data using the method according to the invention according to the first and/or the second and/or the third variant and a review of the influence of filters on the final result because of the constant number 2ⁿ of filters are similar methods that can be carried out independently of one another.

The method according to the invention according to the first and/or the second and/or the third variant can include the step of deleting 2ⁿ filters from the plurality of filters. If all of the 2ⁿ filters are deleted, then this number of filters is made inactive for the method according to the invention. The number of filters to be deleted can be less than or equal to the numerical number of the plurality of filters. This allows the use of computing units comprising an ASIC component with a predetermined computing unit architecture.

The weighting factor can have almost the same values, such as one, for example. With reference to common teaching, a weighting of the filters is achieved in that the weighting factors have such different values that the result data are influenced by the different weighting factors.

It is basically a requirement for the accuracy of the method according to the invention according to the first and/or the second and/or the third variant, whether a weighting factor with a value close to zero and thus a weighting value with a value that differs from zero by a distance value meets the requirement of accuracy placed on the method according to the invention according to the first and/or the second and/or the third variant. The distance value can be defined depending on the defined requirement for accuracy. The distance value can be specified not only with reference to numerical limits, but with regard to the required accuracy. This also applies to a weighting value close to one or close to another value.

The method according to the invention according to the first and/or the second and/or the third variant is characterized at most by the fact that all the filters are always present in terms of circuit arrangement. In contrast to methods according to common teaching, the method according to the invention according to the first and/or the second and/or the third variant is based on a rigid structure. The method according to the invention according to the first and/or the second and/or the third variant can be carried out on a microchip with rigid and therefore unchangeable properties.

The method according to the invention according to the first and/or the second and/or the third variant is based on the basic idea described above that all filters are present in terms of circuit arrangement. With reference to common teaching, a filter can have a low relevance to the result data. In methods according to the background of the art, these filters with low relevance to the result data are deleted, while in the method according to the invention these filters remain active and are optionally associated with a weighting factor of zero or close to zero.

The method according to the invention according to the first and/or the second and/or the third variant can be characterized in that the filter criterion of a selected filter is variable. The method according to the invention according to the first and/or the second and/or the third variant can include routines (“pruning”), by means of which routines the low relevance of a filter is determined and the filter criterion is modified in iterative method steps in such a manner that this filter comprises a filter criterion with a relevance to the result data. The relevance of a filter to the result data can be determined using mathematical methods according to common teaching.

The method according to the invention according to the first and/or the second and/or the third variant can be characterized in that the filter criterion includes filter parameters, which filter parameters are variable. A filter parameter is a value of a filter criterion, which value can be modified such that the filter has relevance to the result data.

For example, when analyzing colors, the filter parameter can be an RGB value or a value describing a color. If a filter has an RGB value that has no relevance to the result data, the filter parameter can be assigned a different value.

The change in a filter parameter described above represents an alternative to the deletion of filters that have no significant influence on the result values, which is known from the background of the art. As already mentioned at the beginning as background of the art, such a method is known by the technical term “pruning”. The method according to the invention according to the first and/or the second and/or the third variant can be supplemented by a “pruning” method according to common teaching, according to which method filters with no significant influence on the result values are deleted. A number of filters can be deleted depending on the defined linking of the individual filtering method steps.

The method according to the invention according to the first and/or the second and/or the third variant is particularly suitable as a method for analyzing data in neural networks.

The method according to the invention according to the first and/or the second and/or the third variant can be supplemented by further method steps within the scope of processing data using neural networks. The result values can be processed in at least one further method step from the group of further method steps with the generation of further result values:
summation,
equalization,
rectification,
pooling.

The further method steps are known according to common teaching.

The invention disclosed herein also relates to a device for data processing comprising means for carrying out the method described in the above general part of the description and below in the description of the figures.

The invention disclosed herein allows the processing of data to be carried out by means of a computer processor with an ASCI component and/or an FPGA component.

The invention disclosed herein also relates to a computer product comprising instructions which, when a computer program is executed by a computer, cause the computer or a computer to execute the method according to the invention according to the first and/or the second and/or the third variant.

The invention disclosed herein also relates to a computer-readable storage medium comprising instructions which, when executed by a computer, cause this computer or a computer to execute the method according to the invention according to the first and/or the second and/or the third variant.

In addition to the method described above in the general part of the description and in the method described below by means of embodiments, the invention disclosed herein also relates to a device for carrying out the method according to the invention according to the first and/or the second and/or the third variant, a computer program comprising instructions for carrying out the method according to the invention according to the first and/or the second and/or the third variant, and a data medium on which a computer program for carrying out the method according to the invention according to the first and/or the second variant is stored.

In the second variant, which is independent of the first variant, the invention relates to a method with the features of the preamble of claim 16, logic modules for carrying out such a method, a logic module with the features of the preamble of claim 30, a device having such a logic module, computer programs for carrying out the method and a storage medium.

The statements below also apply to the invention and can therefore represent exemplary embodiments of the first and/or the second and/or the third variant of the invention.

Neural networks are models of machine learning that, after a suitable configuration (which takes place through a training process, also referred to as learning), generate an output from an input of data by means of a plurality of layers arranged sequentially and/or in parallel as viewed computationally, e.g., to perform a classification. The process of data processing using a configured (i.e. trained) neural network is referred to as inference.

So-called deep neural networks have a number of layers (at least two layers, but usually more than two layers) between an input layer and an output layer, in each of which a number of result data are generated from input data (which have an input data size that usually differs from layer to layer) by means of a number of filters each associated with a layer by linear arithmetic operations. In the case of layers arranged sequentially as viewed computationally, the result data of one layer function as input data of the immediately following layer (wherein at least with respect to selected layers, preferably with respect to all layers) further arithmetic operations can be applied to the result data before they are supplied to the following layer as input data, such as the application of a non-linear activation function—e.g. ReLU or another suitable non-linear activation function—and/or a pooling and/or downsampling method. The application of a non-linear activation function is also referred to as a rectification process.

Deep neural networks in which, by means of a plurality of layers, a number of result data are generated in each case from input data using a number of filters associated in each case with a layer by linear arithmetic operations, wherein filter sizes of the filters associated with a first layer are smaller than the input data size and the filters perform the linear arithmetic operation at different points of the input data, respectively (such layers are hereinafter referred to as first layers in the present disclosure), are referred to as Convolutional Neural Networks (CNN) when an inner product is used as the linear arithmetic operation, so that after the repeated application of a filter there is a convolution.

Before the output layer of the neural network, there are often at least two layers that are tightly connected, i.e. where every element (neuron) of a previous layer is connected to every element (neuron) of the immediately following layer (so-called fully connected layers). In order to distinguish these layers from the first layers discussed at the outset, any layers which are tightly connected to one another are referred to in the present disclosure as second layers. It can also be provided that one of the at least two second layers forms the output layer.

The input data supplied to an input layer of a neural network can be arranged in a grid, wherein the grid can have different dimensions and different numbers of channels (data channel or channel), as the following examples show:
1D grid in 1 channel: Input data in the form of audio signals, wherein the amplitude can be represented along discrete time steps
2D grid in 1 channel Input data in the form of monochrome image signals, wherein greyscale pixels representing the image signal can be represented along a height and width
2D grid in 3 channels: Input data in the form of color image signals, wherein the intensity of one of the colors red, green and blue can be represented in pixels per channel, which can be arranged along a height and a width
3D grid in 1 channel: Input data in the form of volumetric data, e.g. medical imaging
3D grid in 3 channels: Input data in the form of color video data, wherein the intensity of one of the colors red, green and blue can be represented in pixels per channel, which can be arranged along a height and a width, wherein an additional axis represents time

The input data size depends on the amount of input data present in relation to the grid dimensions and channels present and is, for example, p·q·k for input data present in 2D with p·q entries and k channels. Per channel, the input data size is p·q. It should be noted that input data with different input data sizes can be used for one and the same neural network by using filters. The number of channels is sometimes referred to as the depth (not to be confused with the depth of a neural network, which is the number of sequentially arranged layers), so the input data can be said to be present in a height width depth format.

A single filter (often referred to as a kernel) always has the same number of channels as the input data to which it is to be applied, and usually also the same number of dimensions, so that in the case of 2D input data a 2D filter is usually used (the correspondence in the number of dimensions is not necessarily required, however; for example, in the case of 2D input data a 1D filter could be used alternatively). The filter size per channel (also referred to as the receptive field size, in relation to the first layer with which the filter is associated) is smaller than the input data size per channel, usually much smaller (one or more orders of magnitude smaller). The size of the receptive field indicates which section of the input data, to which the filter is applied, the filter captures per channel and per application. For a filter that is in 2D with l·m entries and k channels, the size of the receptive field is l·m and the filter size is l·m·k. With regard to a filter, one can also say that it is present in a height·width·depth format.

Because the size of the receptive field is smaller than the input data size per channel, one and the same filter can be applied at different points of the input data to perform the linear arithmetic operations (floating window operation). Unlike between tightly connected layers, not every element in an immediately following layer as viewed computationally is connected to every element of the immediately preceding layer as viewed computationally.

The so-called stride indicates how far the different points of the input data, at which one and the same filter is applied, are shifted in relation to one another.

The filter can be characterized by at least one filter parameter (e.g. matrix entries in the grid of the filter and/or a bias parameter), so that the multiple application of one and the same filter at different positions of the input data results in a so-called parameter sharing. The computation results of the linear arithmetic operations obtained for each channel in each implementation are summed across all channels to form the result data, which serve as input data for the next layer as viewed computationally. This can be done immediately at each different position or at a later time.

With regard to the multiple application of one and the same filter to input data (floating window operation), it should be noted that this floating window operation can be performed mathematically equivalent in a single work step as a single matrix multiplication by converting the partial data available for each depth dimension of the input data in height and width into a column vector (so-called flattening) and converting the filter into a matrix. Multiplying the vector by the matrix gives the same result data as the floating window operation. Since this process corresponds to the background of the art (see, for example, “Charu C. Aggarwal, Neural Networks and Deep Learning, Springer International Publishing AG 2018, Chapter 8.3.3, page 335ff.§), it is not described in detail here. In relation to the present disclosure, the possibility of such a matrix multiplication is always included when a floating window operation is mentioned or described.

As already explained, input data with a specific dimensionality and a specific number of channels are supplied to the neural network via the input layer. After processing by a first layer, result data are generated from these input data, which have the same dimensionality but usually a different number of channels (and thus a different data size), because the number of channels of the result data of a first layer is given by the number of filters associated with and used by this first layer. If, for example, the input data size of the input data supplied via the input layer is 32·32 in 3 channels and 10 filters are used (with a size of the receptive field of 5·5 and of course 3 channels), then the result data of this first layer will be 28·28 in 10 channels. This result data can be made available to an immediately following further first layer as viewed computationally (usually after applying a non-linear activation function) as input data.

The linear arithmetic operations performed in a first layer and any pooling and/or downsampling methods performed lead to a reduction in the data size per channel.

Padding methods are often used to prevent or reduce a reduction in the data size of the result data.

Mathematically, input data and/or filters that are present in n grid dimensions and m channels can be represented as n m tensors. It should be noted that such tensors can also be represented as vectors while preserving the spatial relationships of the individual elements of the input data.

Several different filters (which differ from one another e.g. by different dimensions and/or filter parameters) are usually used per first layer, wherein the number of channels of each filter must of course correspond to the number of channels of the input data processed by the respective first layer. In the background of the art, the number of filters is different for different first layers.

The inner product is often used as a linear arithmetic operation, wherein the filter sizes of the filters associated with a first layer are smaller than the input data size and the filters each carrying out the linear arithmetic operation at different points in the input data, so that mathematically one can speak of a convolution.

The above statements are of course also applicable within the scope of the first and/or second and/or third variant of the invention and can be used in exemplary embodiments of the first and/or second and/or third variant of the invention.

The object of the second variant of the invention is in particular to provide a computer-implemented method for processing data by means of a neural network which has a plurality of first layers between an input layer and an output layer, wherein filters are associated with each first layer, which method can be implemented in hardware with lower energy consumption and/or at lower cost, to provide a logic module in which such a network is implemented, a device having such a logic module, computer program products for carrying out the method, and a computer-readable storage medium.

This object is achieved by a computer-implemented method having the features of claim 16, logic modules configured to carry out such a method, a logic module having the features of claim 30, a device having such a logic module, a computer program product for carrying out such a method, and a computer-readable storage medium having such a computer program product.

The computer-implemented method according to the second variant of the invention for processing data by means of a neural network provides a neural network which has a plurality of first layers between an input layer and an output layer, wherein filters are associated with each first layer of the plurality of first layers and wherein
in each first layer of the plurality of first layers result data are generated in one or more channels from input data using filters associated with the respective first layer of the plurality of first layers by linear arithmetic operations, wherein the input data have an input data size per channel,
for each first layer of the plurality of first layers the sizes of receptive fields of the filters associated with the first layers are smaller than the input data size per channel of that first layer of the plurality of first layers with which the filters are respectively associated and the filters perform the linear arithmetic operation respectively at different points of the input data,
in at least one first layer of the plurality of first layers a non-linear activation function is applied to the result data for generating result data in the form of activation result data.

With respect to the plurality of first layers present between the input layer and the output layer, according to the second variant of the invention, it is provided that
a number of filters associated with a first layer of the plurality of first layers is the same for each of the first layers of the plurality of first layers, wherein in each of the first layers each of the filters associated with a respective first layer is used for linear arithmetic operations, and
wherein it is preferably provided that each filter is associated with a weighting factor which determines the extent to which the result of the arithmetic operations performed by the respective filter at the different points of the input data is taken into account when generating the result data.

If the data flow is followed along a series of first layers arranged sequentially as viewed computationally, the number of filters associated with the individual first layers thus remains constant.

Because the number of filters associated with a first layer is the same for all first layers arranged between the input layer and the output layer, the result data of each first layer have the same number of channels. If the receptive fields of the various filters are also chosen to be the same, the filter sizes match.

The weighting factors can have different numerical values; these can be trained in a method corresponding to the background of the art (e.g. backpropagation). If the training of the neural network shows that the calculation result of a selected filter has no relevance when determining the result data, this filter is given e.g. a weighting factor with the numerical value of zero or a numerical value close to zero. By choosing an appropriate numerical value, the effect of the selected filter can be fixed (e.g. scaled in relation to other filters), for example by multiplying the calculation result of the filter by its weighting factor.

If the neural network is trained again, the weighting factors can change.

Advantageous embodiments of the invention are defined in the dependent claims.

It can be provided that in at least a first layer of the plurality of first layers, preferably in a plurality of first layers or in all first layers, a non-linear activation function (e.g. ReLU) is applied to the result data for generating result data in the form of activation result data.

It can be provided that in at least one first layer of the plurality of first layers, preferably in a plurality of first layers or in all first layers, reduction methods and/or pooling methods (e.g. Max-Pooling or Average-Pooling) and/or downsampling methods are applied to the number of result data.

It can be provided that in at least one first layer of the plurality of first layers, preferably in a plurality of first layers or in all first layers, the linear arithmetic operations performed at different points of the input data are inner products and the result data are the result of convolutions. In this case, the at least one first layer can be referred to as a convolutional layer and the neural network as a convolutional neural network (CNN).

It can be provided that the neural network has at least two second layers, which are tightly connected to one another, behind the plurality of first layers as viewed computationally, wherein either the output layer is arranged sequentially behind the at least two second layers as viewed computationally or the second layer arranged sequentially as the last as viewed computationally is formed as the output layer.

It can be provided for at least two first layers of the plurality of first layers to be arranged sequentially between the input layer and the output layer as viewed computationally.

It can be provided for at least two first layers of the plurality of first layers to be arranged in parallel between the input layer and the output layer as viewed computationally. At least two data flows can thus take place in parallel.

As in the background of the art, the parameters of the filters can be taught during training of the neural network.

A padding method can be performed on the input data of a first layer.

In a logic module, in particular an ASIC, according to the second variant of the invention, electronic circuit arrangements for performing neural network calculations for a neural network with a plurality of first layers, in particular for performing a method according to the second variant of the invention, are fixed, in the sense that they can no longer be changed after the logic module has been manufactured.

Such a logic module has at least one signal input for supplying input for the neural network and at least one signal output for delivering output. For example, the signal input can communicate directly with an appropriate signal generating device (e.g., a 2D or 3D camera, microphone, sensors for non-visual or non-audible measurements, etc.) or can receive data from memory or from a processor. The signal output can communicate with an imaging device, a memory, a processor or an actuator, e.g. of a vehicle.

Such a logic module also comprises the following:
a plurality of first layer circuit arrangements each representing a first layer of the neural network, each first layer circuit arrangement having at least one signal input for receiving input data and at least one signal output for outputting result data, and each first layer circuit arrangement having at least one first layer in which, in each case in one or more channels, a number of result data can be generated from input data having an input data size per channel using a number of filters associated with the at least one first layer by linear arithmetic operations, wherein the sizes of receptive fields of the filters associated with the at least one first layer are smaller than the input data size per channel of the at least one first layer, and wherein the filters each perform the linear arithmetic operation per channel at different points of the input data, wherein all of the first layer circuit arrangements have the same number of filters associated with the at least one first layer, and wherein in each of the at least one first layers of each first layer circuit arrangement, each of the filters associated with a respective first layer is used for linear arithmetic operations and wherein it is preferably provided that each filter is associated with a weighting factor which determines the extent to which the result of the arithmetic operations performed by the respective filter at the different points of the input data is taken into account in the generation of the result data,
an output circuit arrangement, which is connected to the signal output,
at least one scheduler circuit arrangement, which is in data communication with the plurality of layer circuit arrangements and which is designed to define a network architecture of the neural network in order to specify, according to a changeable specification, the order in which a data flow is conducted from the signal input of the logic module to the individual layer circuit arrangements, between the individual layer circuit arrangements and from the individual layer circuit arrangements to the output circuit arrangement.

In such a logic module, a neural network is configured whose individual layer circuit arrangements are fixed, in the sense that they can no longer be changed after the logic module has been manufactured, but for which different network architectures can be realised for one and the same logic module by corresponding specification to the scheduler circuit arrangement.

The first layer circuit arrangement, which as viewed computationally directly receives a data flow from the signal input, represents the input layer of the neural network. The output circuit arrangement represents the output layer of the neural network. The data flow between the first layer circuit arrangements takes place in such a manner as corresponds to the network architecture specified by the scheduler circuit arrangement in accordance with a changeable specification.

Advantageous embodiments of the logic module according to the second variant of the invention are defined in the dependent claims.

The logic module according to the second variant of the invention is preferably provided for the inference operation of the neural network, such that a subsequent change in the number of filters (of course so that all first layer circuit arrangements always have the same number of filters) and/or of filter parameters and/or receptive field and/or of weighting factors is not required. For this reason, they can preferably be configured in a fixed manner, i.e. unchangeably, in the logic module. However, it can alternatively be provided that these variables are stored in a RAM circuit arrangement of the logic module such that they can be changed.

It can be provided that in at least one first layer circuit arrangement of the plurality of first layer circuit arrangements, preferably in a plurality of first layer circuit arrangements or in all first layer circuit arrangements, the linear arithmetic operations performed on different points of the input data are inner products and the result data are the result of convolutions. In this case, the at least one first layer circuit arrangement can be referred to as a convolutional layer circuit arrangement and the neural network configured in the logic module can be referred to as a convolutional neural network (CNN).

It can be provided that in at least one first layer circuit arrangement, preferably in a plurality of first layer circuit arrangements or in all first layer circuit arrangements, at least one, preferably several or all functional module(s) selected from the list below are formed:
a cache memory system,
a bias module to remove any bias that may be present,
a rectification module for performing a rectification process,
a pooling module for performing a pooling method, e.g. Max-Pooling or Average-Pooling,
an activation module for executing a non-linear activation function to generate result data in the form of activation result data,
a padding module for carrying out a padding method.

It can be provided that in at least one first layer circuit arrangement of the plurality of first layer circuit arrangements, preferably in a plurality of first layer circuit arrangements or in all first layer circuit arrangements, several (e.g. all of the functional modules specified in the above list) are fixed and it can be specified (for example via the scheduler) which of the functional modules is to be active in the at least one first layer circuit arrangement of the plurality of first layer circuit arrangements, preferably in a plurality of first layer circuit arrangements or in all first layer circuit arrangements, and which is not to be active. Thus, it is possible that several or all of the first layer circuit arrangements are configured with the same fixed functional modules, but they still differ from one another in their functionality if the same functional modules are not switched to be active in all layer circuit arrangements.

The functionalities of the individual functional modules are explained below.

In the cache memory system, with respect to each of the filters of a first layer circuit arrangement, a summation of the linear arithmetic operation performed by the filter for each channel can be performed over all channels. Additionally or alternatively, other terms may be summed to the result of the linear arithmetic operation, such as terms coming from other first layer circuit arrangement. Different summations can be provided in cache memory arrangements of different first layer circuit arrangements.

In the bias module, a possibly existing bias can be removed in order to avoid an undesired numerical growth of the results of the linear arithmetic operations.

A non-linear activation function (e.g. ReLU) can be performed in the rectification module to generate result data in the form of activation result data. Various non-linear activation functions can be provided in the activation modules of different first layer circuit arrangements.

A pooling and/or downsampling method designed according to the background of the art can be carried out in the pooling module. Different pooling and/or downsampling methods can be provided in the pooling modules of different first layer circuit arrangements.

It can be provided that a network architecture is defined by the scheduler circuit arrangement such that
at least two first layer circuit arrangements are arranged sequentially between the input layer and the output layer as viewed computationally and/or
at least two first layer circuit arrangements are arranged in parallel between the input layer and the output layer as viewed computationally.

It can be provided that a network architecture is defined by the scheduler circuit arrangement in such a manner that a data flow is conducted from at least one functional module of a first layer circuit arrangement directly to at least one functional module of another first layer circuit arrangement, i.e. without going via the signal output of the one first layer circuit arrangement to the signal input of the other circuit arrangement. For example, it can be provided that result data of linear arithmetic operations of the one first layer circuit arrangement—possibly together with result data of linear arithmetic operations of the other first layer circuit arrangement—are supplied to an activation module in the other layer circuit arrangement for executing a non-linear activation function for generating result data in the form of activation result data.

It can be provided that a network architecture is defined by the scheduler circuit arrangement in such a manner that at least one first layer circuit arrangement is traversed more than once with respect to the data flow, i.e. that the data flow runs at least once in the course of the calculation from the signal output of this at least one first layer circuit arrangement to the signal input of this at least one first layer circuit arrangement.

It can be provided for at least two second layer circuit arrangements to be fixedly predetermined in the logic module, which represent tightly interconnected second layers, wherein either the output layer is arranged sequentially behind the at least two second layers as viewed computationally (i.e. in relation to the data flow) or the second layer arranged sequentially as the last as viewed computationally is formed as the output layer.

In a device having a logic module according to the second variant of the invention, it is provided that signals can be supplied to the at least one logic module as input for the neural network calculations via at least one signal input by at least one signal generating device arranged on or in the device, and wherein the at least one logic module has at least one signal output for communication with a control or regulating device of the device or for the output of control commands to at least one actuator of the device. This can be used for assistance operation or for autonomous operation of the device. The device can be designed, for example, as a vehicle or as a robot.

In the third variant, which is independent of the first and second variants, the invention relates to a method with the features of the preamble of claim 23, logic modules for carrying out such a method, a device having such a logic module, computer programs for carrying out the method and a storage medium.

The configuration of neural networks on logic modules such as FPGAs and ASICs is often difficult due to the high computing power required and the massive memory requirements.

The publication “An Overview of Arithmetic Adaptations for Inference of Convolutional Neural Networks on Re-configurable Hardware” by Ilkay Wunderlich, Benjamin Koch and Sven Schönfeld (https://www.iaria.org/conferences2020/ProgramALLDATA20.html) presents strategies as to how this porting can be achieved in such a manner that less computing power and less memory is required. The main focus is on a so-called quantization, in which a floating number arithmetic is used as the basic arithmetic structure during the training of the neural network and an integer arithmetic is used during the inference operation, wherein the parameter values of the neural network determined as floating numbers during training are quantized by multiplication with a scaling factor and subsequent rounding to integer values. This also applies to the arithmetic operations of the neural network, e.g. the convolution operation can be performed on the basis of int32 and/or a quantized non-linear activation function can be used as the non-linear activation function.

The measures discussed in the publication, which can also be used in the first, second or third variant of the invention, significantly accelerated the inference operation of a neural network that was trained outside of a logic module and ported to a logic module.

The object of the third variant of the invention is in particular to provide a computer-implemented method for processing data by means of a neural network, which allows for faster inference operation when implemented in a logic module, the provision of a logic module in which such a neural network is implemented, a device with such a logic module, computer program products for carrying out the method and a computer-readable storage medium.

This object is achieved by a computer-implemented method having the features of claim 23, logic modules designed to carry out such a method, a device having such a logic module, a computer program product for carrying out such a method and a computer-readable storage medium having such a computer program product.

The method according to the third variant of the invention provides a computer-implemented method for processing data by means of a neural network, wherein the neural network comprises a plurality of first layers between an input layer and an output layer (wherein filters can be associated with each first layer of the plurality of first layers) and wherein
in each first layer of the plurality of first layers, result data are generated in one or more channels from input data (preferably using filters associated with the respective first layer of the plurality of first layers) by linear arithmetic operations, wherein the input data have an input data size per channel,
(optionally: for each first layer of the plurality of first layers the sizes of receptive fields of the filters associated with the first layers are smaller than the input data size per channel of that first layer of the plurality of first layers with which the filters are respectively associated and the filters perform the linear arithmetic operation respectively at different points of the input data)
in at least one first layer of the plurality of first layers a non-linear activation function is applied to the result data for generating result data in the form of activation result data,
during a training of the neural network (which preferably takes place outside a logic module) in the at least one first layer of the plurality of first layers, preferably in all first layers of the plurality of first layers, a non-linear activation function having a first image area is used to generate the activation result data,
during an inference operation of the neural network, which is preferably performed using a logic module, in the at least one first layer of the plurality of first layers, preferably in all first layers of the plurality of first layers, a non-linear activation function with a second image area is used to generate the activation result data, wherein the second image area forms a true subset of the first image area.

The use of a non-linear activation function with a second image area (in which the activation result data resides) that is a true subset of the first image area (i.e. the first and second image areas are not identical) is referred to in the following as “activation clipping”.

With activation clipping, the value range of the activation result data is restricted (from the larger first image area to the smaller second image area). For this purpose, e.g. values are set for a lower and/or an upper bound, which are referred to as “Lower Bound L” and “Upper Bound U” by way of example. The numerical values of the upper and lower bound can e.g. be the same except for the sign, or they can have different numerical values. Equivalent to the definition of a lower and/or upper bound, a corresponding range can of course be defined.

The person skilled in the art selects the upper bound and/or lower bound to increase the speed of carrying out the method according to the invention, taking into account the accuracy to be achieved. Choosing such a small range that the upper bound corresponds close to the lower bound or the upper bound corresponds to the lower bound can entail a reduction in the accuracy of the method according to the invention.

A function that can be used to perform activation clipping by way of example is hereinafter referred to as a “clipped” activation function or “clipping function”, and can be defined in such a manner that result data of the non-linear activation function that are above/below the upper/lower bound during inference operation of the neural network are mapped to the upper/lower bound, and such result data that is between the upper and lower bounds remains unchanged. In this case, between the upper and the lower bounds, the result data will have a course corresponding to the non-linear activation function already selected in the training, while outside these bounds, there is a constant value in the form of the selected upper and lower bound, respectively, so that the (second) image area of the clipped activation function is a real subset of the (first) image area of the non-linear activation function used in the training.

It should be noted that there are some non-linear activation functions that already contain lower and upper bounds for the value range, such as the ReLU-6 function with L=0 and U=6. However, such activation functions, when already used in training, provide significantly lower accuracy than when a non-linear activation function, such as LReLU, is used in training and a clipped activation function is used in inference operation. The non-linear activation function used in training can have an unrestricted (first) image area.

Activation clipping increases the speed of the inference operation of a neural network configured on a logic module. For example, when porting a TinyYOLOv3 CNN with an input size of 320×320×3 to classify objects or people in a camera image or video stream, an increase in frame rate of about 50% was achieved when ported to a XILINX Artix-7 FPGA, which means reduced latency.

It is particularly preferred to use non-linear activation functions during training and during inference operation of the neural network that are identical except for the different image areas (e.g., LReLU during training and an activation function clip-LReLU resulting from the composition of LReLU with a clip function).

Either of the following can be provided for carrying out the activation clipping:
In a first step, to use a non-linear activation function that has the first image area (preferably the activation function that was already used during training) and then, in a second step, reduce the first image area to the second image area (i.e. clipping only after activation), or
to immediately use a non-linear activation function that already has the second image area (i.e. use an activation function that has already been clipped during activation so that clipping is no longer required as a separate step).

It is preferred that a ReLU function or a leaky ReLU function (LReLU) is used as the non-linear activation function. These functions are characterized by lower complexity compared to other non-linear activation functions such as tanh, which makes them less computationally expensive and easier to implement in hardware with fixed-point arithmetic.

It can be provided that a floating number arithmetic is used during the training of the neural network, which is quantized to an integer arithmetic for the inference operation of the neural network.

It can be provided that a mapping operation is applied to the result activation data located in the second image area, which maps the result activation data to a predetermined integer data type, preferably uint8, as already described in the above-cited publication on the quantization of neural networks.

It can be provided that a demapping operation is applied to the result activation data mapped to the predetermined data type before generating result data in a subsequent first layer of the plurality of first layers by linear arithmetic operations (preferably using filters associated with the subsequent first layer), as already described in the publication on quantization of neural networks cited above.

The first variant of the invention, the second variant of the invention and the third variant of the invention can be used together. The statements made in relation to one variant of the invention are also applicable in relation to the other variants of the invention. In particular, the novel method described in relation to the first variant of the invention for determining an optimal number of filters (e.g. further development of the “pruning” or “spiking” method) can also be used in the second and/or the third variant of the invention.

Filters which can be used in the method according to the invention according to the first and/or second and/or the third variant of the invention are shown by way of example in FIG. 1. The method according to the first variant of the invention is explained by the attached FIGS. 2 to 6, a method according to the second variant of the invention, a logic device according to the invention, a representation of a neural network, which can be calculated by the method according to the second variant of the invention and/or represented in the logic device according to the invention, and devices having a logic device according to the invention are shown in FIGS. 7 to 11, a method according to the third variant of the invention is shown in FIGS. 12 to 14, wherein the abbreviations contained in the figures denote the following elements.
ID, ID #, ID″ Input data
OD Result data (output data)
WF Weighting factor
1 (First) filtering method step
2 (Second) filtering method step
3 Feedback of the result data as input data
4 Rectangle
5 Circuit
6 Device
7 Logic module
8 Control or regulating device of the device
9 Signal generating device
10 Actuators of the device
100 Neural network
101 First layer
102 Second layer
103 Input layer
104 Output layer
105 Filters
200 Logic module
201 First layer circuit arrangement
202 Second layer circuit arrangement
203 Signal input
204 Signal output
205 Scheduler circuit arrangement
206 RAM circuit arrangement
207 Cache memory system
208 BIAS module
209 Rectification module
210 Pooling module
211 Padding module

1-40. (canceled)

41. A computer-implemented method for processing data, the data being stored in a database or determined by a sensor, comprising:
analyzing the input data using a number of serially arranged filters defining a filter criterion; and
generating result data in a plurality of serial filtering method steps;
wherein the result data corresponds to the filter criterion and comprises result values;
wherein a weighting factor is associated with each filter; and
wherein the number of filters in the filtering method steps is constant.

42. A computer-implemented method for processing data in neural networks, the method comprising:
analyzing input data using a number of at least one filter defining a filter criterion and arranged in parallel and generating result data in parallel filtering method steps; and
generating result data corresponding to the filter criterion and comprising result values;
wherein a weighting factor is associated with each filter; and
wherein the number of filters in the filtering method steps is constant.

43. The method according to claim 41 wherein the result data are combined in a result matrix.

44. The method according to claim 41, wherein a weighting factor is zero.

45. The method according to claim 41, wherein a weighting factor is non-zero.

46. The method according to claim 41, wherein a weighting factor is one.

47. The method according to claim 41, wherein the filter criterion of a selected filter can be defined.

48. The method according to claim 47, wherein the filter criterion comprises filter parameters which filter parameters can be changed.

49. The method according to claim 42, wherein a plurality of further input data are created from the input data, which further input data comprise the same data.

50. The method according to claim 41, wherein the result data are combined in a result data matrix using a reduction method.

51. A computer-implemented method for processing data by means of a neural network according to claim 41, wherein:
the neural network comprises a plurality of first layers between an input layer and an output layer, wherein filters are associated with each first layer of the plurality of first layers;
in each first layer of the plurality of first layers result data are generated in one or more channels from input data using filters associated with the respective first layer of the plurality of first layers by linear arithmetic operations, wherein the input data have an input data size per channel;
for each first layer of the plurality of first layers the sizes of receptive fields of the filters associated with the first layers are smaller than the input data size per channel of that first layer of the plurality of first layers with which the filters are respectively associated and the filters perform the linear arithmetic operation respectively at different points of the input data;
in at least one first layer of the plurality of first layers a non-linear activation function is applied to the result data for generating result data in the form of activation result data;
with respect to the plurality of first layers present between the input layer and the output layer;
a number of filters associated with a first layer of the plurality of first layers is the same for each of the first layers of the plurality of first layers; and
in each of the first layers each of the filters associated with a respective first layer is used for linear arithmetic operations.

52. The method according to claim 51, wherein each filter is associated with a weighting factor which determines the extent to which the result of the arithmetic operations performed by the respective filter at the different points of the input data is taken into account when generating the result data.

53. The method according to claim 51, wherein in a plurality of first layers or in all first layers a non-linear activation function is applied to the result data for generating result data in the form of activation result data.

54. The method according to claim 51, wherein at least one of reduction methods, pooling methods, and downsampling methods are applied to the number of result data in at least one first layer of the plurality of first layers, preferably in a plurality of first layers or in all first layers.

55. The method according to claim 51, wherein in at least one first layer of the plurality of first layers, preferably in a plurality of first layers or in all first layers, the linear arithmetic operations performed at different points of the input data are inner products and the result data are the result of convolutions.

56. The method according to claim 52, wherein:
the neural network has at least two second layers, which are tightly connected to one another, behind the plurality of first layers as viewed computationally; and
either the output layer is arranged sequentially behind the at least two second layers as viewed computationally or the second layer arranged sequentially as the last as viewed computationally is formed as the output layer.

57. The method according to claim 51, wherein at least two first layers of the plurality of first layers are arranged sequentially between the input layer and the output layer as viewed computationally.

58. The method according to claim 51, wherein at least two first layers of the plurality of first layers are arranged in parallel between the input layer and the output layer as viewed computationally.

59. A computer-implemented method for processing data by means of a neural network according to claim 42, wherein:
the neural network comprises a plurality of first layers between an input layer and an output layer, wherein filters are associated with each first layer of the plurality of first layers;
in each first layer of the plurality of first layers result data are generated in one or more channels from input data using filters associated with the respective first layer of the plurality of first layers by linear arithmetic operations;
the input data have an input data size per channel;
for each first layer of the plurality of first layers the sizes of receptive fields of the filters associated with the first layers are smaller than the input data size per channel of that first layer of the plurality of first layers with which the filters are respectively associated and the filters perform the linear arithmetic operation respectively at different points of the input data;
in at least one first layer of the plurality of first layers a non-linear activation function is applied to the result data for generating result data in the form of activation result data, with respect to the plurality of first layers present between the input layer and the output layer;
a number of filters associated with a first layer of the plurality of first layers is the same for each of the first layers of the plurality of first layers; and
in each of the first layers each of the filters associated with a respective first layer is used for linear arithmetic operations.

60. A computer-implemented method for processing data by means of a neural network, the neural network comprising a plurality of first layers between an input layer and an output layer, filters being associated with each first layer of the plurality of first layers, the method comprising:
generating, in each first layer of the plurality of first layers, result data in one or more channels from input data using filters associated with the respective first layer of the plurality of first layers by linear arithmetic operations;
wherein the input data have an input data size per channel;
wherein for each first layer of the plurality of first layers the sizes of receptive fields of the filters associated with the first layers are smaller than the input data size per channel of that first layer of the plurality of first layers with which the filters are respectively associated and the filters perform the linear arithmetic operation respectively at different points of the input data;
wherein in at least one first layer of the plurality of first layers a non-linear activation function is applied to the result data for generating result data in the form of activation result data;
wherein with respect to the plurality of first layers present between the input layer and the output layer; and
wherein a number of filters associated with a first layer of the plurality of first layers is the same for each of the first layers of the plurality of first layers, wherein in each of the first layers each of the filters associated with a respective first layer is used for linear arithmetic operations.
